(19) United States
(12) Patent Application Publication
(10) Pub. No.: US 2006/0000752 A1
(43) Pub. Date: Jan. 5, 2006

(54) Stack correction system and method

(75) Inventors: Andrew Mark Stubleski, Columbia, MD (US); Mark David Bittenbender, Columbia, MD (US); Pierre Jacques Campagnolle, Beaumont Les Valence (FR); Dominique Andre Zaragoza, Jessup, MD (US)

Correspondence Address: ROTHWELL, FIGG, ERNST & MANBECK, P.C., 1425 K STREET, N.W., SUITE 800, WASHINGTON, DC, 20005, US

(73) Assignee: NORTHROP GRUMMAN CORPORATION, Los Angeles, CA (US)

(21) Appl. No.: 10/400,522

(22) Filed: Mar. 28, 2003

(51) Int. Cl. B03B 1/00; B03D 3/00

(52) U.S. Cl. 209/3

(57) ABSTRACT

Preferred embodiments pertain to a mail (e.g., mail flats) stack correction system. In some embodiments, the system can include a transporter having a laterally movable transport surface, a first moving device connected to the transporter, a pusher having a generally upright pusher surface movable generally over the transport surface, a second moving device connected to the pusher, at least one detector positioned to detect stack errors of flats located on the transport surface, and at least one controller configured to control at least one of the first and second moving devices in response to detection by the detector.

### BACKGROUND OF THE INVENTION

1. Field of the Invention

The present invention relates generally to, among other things, systems for handling mail (including, e.g., flats, envelopes, letters, postcards and/or other mail) and/or other thin objects, and certain preferred embodiments relate, more particularly, to automated systems for sorting mail flats.

2. Background Discussion

The following discussion is based on the inventors' knowledge and should not be construed as admissions of knowledge in the prior art.

In certain background mail processing automation systems, feeders are used to deliver mail into the systems for processing. In certain instances, these feeders include a delivery system and a destacking (e.g., singulating) system. In such systems, mail is placed onto the delivery system and delivered to the destacking system. The mail pieces are usually delivered to a sorting section in pieces (e.g., usually having a fixed gap and/or a fixed pitch).

In such systems, operators load (e.g., manually) the mail to be processed onto the delivery system at the beginning of the operation. The operators also continue to load mail while the system is processing mail. In some instances, mail can be loaded from hampers H similar to that shown in FIG. 4.

Typically, mail processing delivery systems include both a transport system (e.g., a belt or magazine conveyor) and a pusher (e.g., paddle) system that work in tandem to deliver mail to the destacking system. In such systems, the transport system defines the rate at which the mail is delivered to the destacking system. In addition, the pusher system defines the orientation angle at which the mail is presented to the destacking system. In such systems, the transport system and the pusher system move together synchronously and are physically coupled to the same drive chain. In this manner, the pusher system acts as a “bookend” for the stack of mail as the mail is transported via the transport system.

The present inventors have found that a system's performance can be enhanced or degraded by the “quality” of a stack as it is being presented to the downstream system, such as a destacking system. For example, mail that is either too loose or that is too tight can cause problems, such as for example, system jams, multi-feeds (where, e.g., more than one piece is inducted into the system), system and/or mail damage, adverse effects on the system throughput and/or other problems. In many cases, the orientation angle of the mail (e.g., relative to the face of the pusher) can significantly affect the system. For example, if the mail is slumped (such as, e.g., in a manner similar to that denoted by dashed lines A shown in FIG. 1) the system's performance can substantially degrade. The present inventors have found that, in some instances, it can be helpful to present the mail to the destacking system such that it is generally uniformly aligned with an angle of the pusher system (such as, e.g., in a manner similar to that shown in FIG. 1).

In modern-day mail processing environments, sorting systems often run faster and longer than in the past. Among other things, this may elevate the demands placed upon the operators who feed the systems. For instance, the demands to present more mail and/or to present mail at a faster rate can, e.g., reduce the amount of time available for operators to adjust, groom and/or otherwise manipulate the mail on the delivery system (e.g., to ensure that it is properly oriented for, for instance, efficient destacking). In many instances, the performance of mail processing equipment is increasingly dependant upon an operator's capacity to support the delivery system.

With existing mail feeding systems that have a transport system and a pusher system that are tied together through a single drive mechanism, the synchronous nature of these systems inhibits them from being able to automatically compensate for poorly stacked mail (e.g., leaning too far forward [such as, e.g., in a manner similar to that denoted by dashed lines B shown in FIG. 1] and/or too far backward [such as, e.g., in a manner similar to that denoted by dashed lines A shown in FIG. 1]). These existing systems rely on the operator to correct stacking problems on the delivery system. FIG. 1 illustrates, among other things, several states of how the mail can be presented to the destacking unit, with an illustrative preferred state shown in solid lines.

The stack of flats depicted in solid lines in FIG. 1 depicts one optimal condition for presenting the flats (e.g., mail) to a destacking system in preferred embodiments. With systems as described above, an operator would need to repeatedly groom (e.g., manually handle and/or manipulate) the mail as it is fed into the destacking section. Otherwise, the angle of orientation relative to the paddle will likely vary too substantially. As a result, the variation in orientation angle will likely cause a decrease in throughput, an increase in multi-feeds, an increase in damage and/or other problems.

Therefore, a need exists for a flats stack correction system that can overcome, among other things, the above and/or other problems with existing systems.

### SUMMARY OF THE INVENTION

Various embodiments of the present invention can significantly improve upon existing systems and methods. In some preferred embodiments of the present invention, one or more of the above and/or other problems with existing systems can be overcome.

According to a first embodiment, a system for automated correction of a stack of mail is provided that includes: a) a transporter having an endless transport belt upon which mail can be conveyed; b) a first moving mechanism connected to the transporter to move the transport belt; c) a generally upright pusher that is movable generally parallel to and over the transport belt; d) a second moving mechanism connected to the pusher and independent of the moving mechanism; e) at least one detector positioned to detect orientation of mail located upon the transport belt; and f) at least one controller configured to control at least one of the first and second moving devices in response to detection by the detector of an orientation error of mail on the transport belt, the controller including at least one computer.

According to another embodiment, s system for correcting a stack of thin objects is provided that comprises: a) a transporter having a transport surface; b) a first moving device connected to the transporter; c) a pusher having a generally upright pusher surface movable generally over the transport surface; d) a second moving device connected to the pusher; e) at least one detector positioned to detect stack errors of thin objects located on the transport surface; f) at least one controller configured to control at least one of the first and second moving devices in response to detection by the detector.

According to another embodiment, a system for correcting a stack of thin objects is provided that comprises: a) a transporter having a laterally movable transport surface; b) a pusher having a generally upright pusher surface movable generally along the transport surface; c) the transport surface being movable to transport thin objects and the pusher being movable generally parallel to the transport surface; and d) means for controlling the transporter and the pusher to change their relative speeds of movement based on a detected stack error.

According to another embodiment, a method for correcting a stack of thin objects includes: a) locating thin objects on a transporter having a transport surface; b) moving the thin objects upon the transport surface while a pusher supports the flats in a generally upright orientation; and c) adjusting the relative speeds of the transporter and the pusher upon the detection of a stack error.

According to another embodiment, a method for upgrading a mail sorting system having a transporter upon which mail is supported for movement and a pusher against which mail is supported during movement, wherein the pusher and the transporter are originally connected to move synchronously via the same drive mechanism, includes: a) replacing the single drive mechanism with independent drive mechanisms for the transporter and the pusher; and b) controlling the independent drive mechanisms to move the transporter and the pusher at different relative speeds based upon errors in the orientation of mail upon the transporter.

The above and/or other aspects, features and/or advantages of various embodiments will be further appreciated in view of the following description in conjunction with the accompanying figures. Various embodiments can include and/or exclude different aspects, features and/or advantages. In addition, various embodiments can combine one or more aspect or feature from other embodiments. The descriptions of aspects, features and/or advantages of particular embodiments should not be construed as limiting other embodiments or the claims.

### BRIEF DESCRIPTION OF THE DRAWINGS

The accompanying figures are provided by way of example, without limiting the broad scope of the invention or various other embodiments, wherein:

FIG. 1 is a schematic side view of a flats stack correction system according to some embodiments;

FIG. 2 is a side view of an illustrative flats sorting system with an improper flats stack presentation;

FIG. 3 is a schematic diagram depicting approximate flats configurations in some illustrative and non-limiting embodiments;

FIG. 4 is an elevational side view of a plurality flats stack correction systems with respective operators according to some embodiments;

FIG. 5 is a rear-side elevational view of an illustrative flats stack correction system according to some embodiments, with system housing and structure removed to reveal internal components; and

FIG. 6 is a rear-side elevational view of the structure shown in FIG. 5 with components removed to reveal separate drive chains according to some embodiments.

### DETAILED DESCRIPTION OF THE PREFERRED EMBODIMENTS

The preferred embodiments provide a substantially or entirely automated stack correction system for use in the processing of thin objects (including, e.g., three-dimensional objects having a size in first dimension that is substantially smaller than sizes in second and third dimensions). While the preferred embodiments can be used to process mail (including, for example, flats, envelopes, letters, postcards and/or other mail), and the most preferred embodiments can be used to process mail flats, various embodiments can also or can alternatively be used to process other thin objects, such as, e.g., sheets, boards, panels, magazines, paper goods and/or other thin objects.

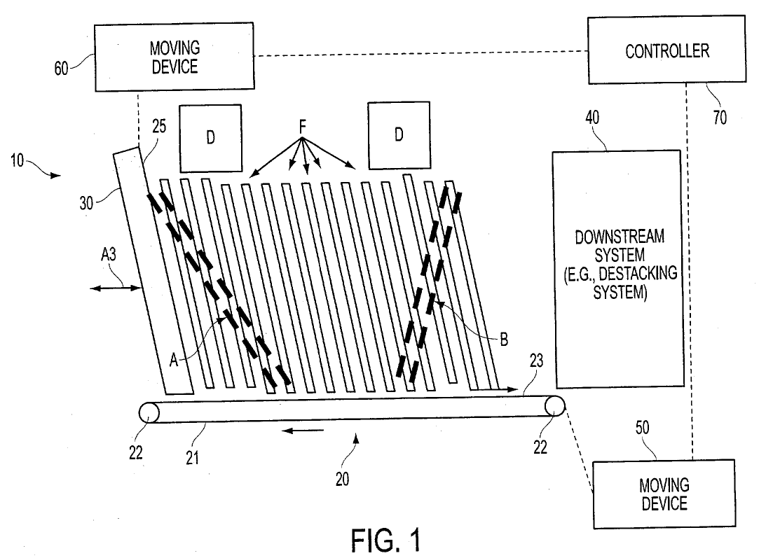

Various embodiments of the present invention can be employed in a variety of systems and devices. In one non-limiting example, embodiments of the present invention can be employed within systems similar to that shown in U.S. Pat. No. 6,443,311 (the '311 patent), assigned to Northrop Grumman Corporation, entitled Flats Bundle Collator, the disclosure of which is incorporated herein by reference in its entirety as though recited herein in full, such as, e.g., to upgrade the feeder 10 shown in FIG. 1 of the '311 patent.

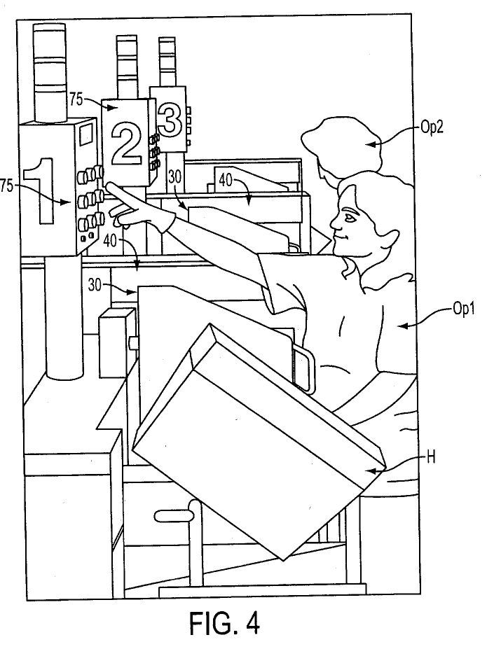

Additionally, various embodiments of the present invention can be employed, in other non-limiting examples, within an AFSM100™ flats sorting machine (see similar systems depicted in FIG. 4) built by Northrop Grumman Corporation and Rapistan Systems and used by the United States Postal Service (USPS). The AFSM100 flats sorting machine is a mail sorting system that can process, e.g., large pieces of flat mail, such as for example magazines, in large volumes. Each AFSM100 system has three mail-feeding units and embodiments of the present invention can be utilized to improve one or more, preferably all, of these mail-feeding units. In some preferred embodiments, an AFSM100 system is adapted to employ automatic flats stack correction by, e.g., splitting a mail delivery system into two separately controlled components such that, e.g., the machine can deliver mail more efficiently to a sorting unit. Preferably, this is accomplished substantially independently of an operator.

FIG. 1 shows an illustrative stack correction device 10 that can be employed in some preferred embodiments of the invention. In preferred embodiments, a stack correction device includes a transporter 20 and a pusher 30 as shown in FIG. 1.

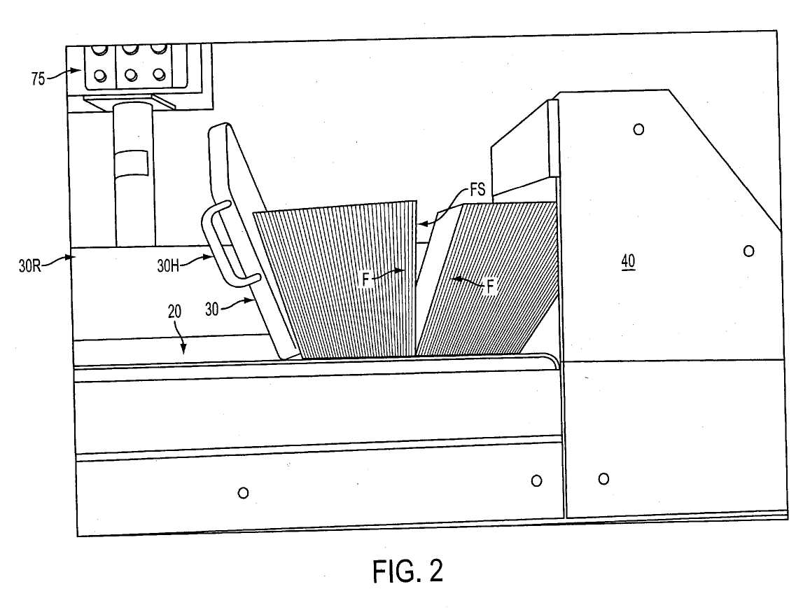

While in some illustrative embodiments, the pusher includes a paddle as shown in FIG. 1, the pusher can have a variety of configurations and can, for example, be made with at least one block-shaped member, at least one wedge-shaped member, a plurality of sub-members (such as, e.g., cross-bars, etc.), at least one blade member and/or any other appropriate structure capable of defining an object holding surface 25. In some preferred embodiments, the object holding surface 25 can have a single contact section (see, e.g., FIG. 1), while in other preferred embodiments it can have a plurality of contact sections. In some preferred embodiments, the object holding surface 25 can be generally planar (see, e.g., FIG. 1), while in other preferred embodiments it can be substantially non-planar. It should also be noted that the pusher itself need not be tilted so long as it is configured to define a mail holding surface 25 having an appropriate orientation. In some preferred embodiments, the surface 25 is oriented at a non-perpendicular angle relative to a transport surface 23 of the transporter 20. Preferably, the pusher is adapted to move fore-and-aft in the direction of the arrows A3, while retaining a substantially non-perpendicular or reclined orientation as shown in FIG. 1. In some preferred embodiments, the angle of recline can vary from about 10° from perpendicular to about 20° from perpendicular; however, the angle of recline can vary from 0° (i.e., perpendicular) to over 20° based on circumstances. In some embodiments, the pusher can be mounted such that, when desired, it can be manually grasped via a handle 30H, shown in FIG. 2, raised upward and moved back to a left side of the transporter 20 to support additional flats or the like. In the latter embodiments, the pusher 30 is preferably disengaged from an associated drive mechanism upon being lifted and re-engaged with its associated drive mechanism upon being lowered back toward the conveyor belt 120.

With respect to the transporter 20, various embodiments of the invention can employ any appropriate structure that is known or available. In some embodiments, the transporter 20 can include a conveyor, a sliding plate, a laterally moved support, a trolley, a plurality of rollers, an inclined plate and/or any other appropriate transporter mechanism known or available having, e.g., a transport surface 23 with which objects may be transported. In that regard, the transport surface 23 can include, e.g., one or more conveyor belt surface(s), one or more sliding plate surface(s), one or more laterally moved support surface(s), one or more trolley surface(s), one or more roller surface(s), one or more inclined plate surface(s) and/or other appropriate surfaces. In some preferred embodiments, the surface 23 can include a single section (such as, e.g., an outer surface of a single conveyor belt as shown), while in other preferred embodiments it can have a plurality of sections (such as, e.g., outer surfaces of a plurality of separate conveyors, rollers or the like). In some preferred embodiments, the surface 23 can be generally planar and generally horizontal (see, e.g., FIG. 1), while in other preferred embodiments it can be substantially non-planar and/or substantially non-horizontal.

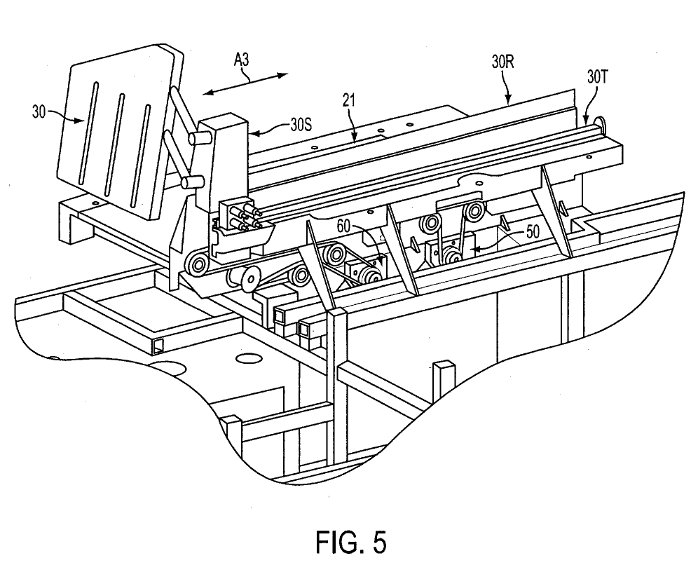

In the embodiment shown in FIG. 1, the transporter 20 can be configured to transport flats F towards a downstream system 40. The system 40 can include any appropriate system, and, in some preferred embodiments, the system 40 is a destacking system. A destacking system can, e.g., singulate and/or feed flats to other systems or devices. In some preferred embodiments, the transporter 20 can include a conveyor belt 21 that is rotatably supported on rollers or pulleys 22 in a continuous manner to define an upper run or surface 23 upon which a stack of mail can be placed. The mail transport surface 23 is preferably parallel to the direction of travel of the pusher 30 as indicated by arrows A3 but may be oriented at a slight angle relative to the direction of pusher travel based on circumstances. As shown, a moving device 50 (such as, e.g., a motor and/or another mechanism for effecting movement of the transporter 20) is preferably included. In one illustrative example, the moving device 50 can include a motor that is connected so as to rotate the pulley(s) 22. In addition, a second moving device 60 (e.g., a motor and/or another mechanism for effecting movement of the pusher in the direction of the arrows A3) is also preferably included. The pusher can be, for example, supported on a support block 30S that is mounted so as to laterally move along a linear track 30T (e.g., via roller bearings or the like) as shown in FIG. 5. In some embodiments, the linear track 30T and the support block 30S can be located adjacent the transporter surface and behind a retaining wall 30R that helps maintain flats upon the transporter (such as, e.g., shown in FIGS. 2 and 5). In other embodiments, various other mechanisms could be used to move the pusher fore-and-aft substantially in the direction of the arrows A3, such as screw shafts, reciprocating arms and/or other mechanisms.

In preferred embodiments, the pusher and transporter systems are adapted to be capable of moving non-synchronously and/or independently from one another in a manner to correct for poor stack angle. In preferred embodiments, the moving devices 50 and 60 are independent devices, such as, e.g., independent servomotors. As discussed above, a variety of mechanisms can be used to effect movement of the transporter and the pusher.

In the embodiment shown in FIG. 1, the moving devices 50 and 60 are both operated via a common controller 70. The controller can include, for example, an electronic control means, such as a computer (e.g., a personal computer [PC], a network computer, a server and/or any other computer device, such as any device that accepts information [e.g., in the form of, e.g., digital data] and processes it based on programming or a sequence of instructions), a processor (e.g., a microprocessor), or the like. In some embodiments, separate controllers can be employed to operate each respective moving device 50 and 60. In some embodiments, the controller 70 can include a plurality of controllers.

In some embodiments, the controller 70 can include software to control separated pusher and transporter mechanisms using, for example, programmable logic controllers (PLCs), one or more external personal computer (PC) or the like, one or more programmable servo drive and/or other devices. In addition, in preferred embodiments, control is carried out based on input from one or more sensor device(s) D. The sensor device(s) D can be used to sense, detect, estimate and/or otherwise evaluate the condition of the flats (such as, e.g., flat orientation). In some embodiments, the sensor device(s) D can sense flat orientation at a plurality of positions along the transporter 20, or along substantially the entire length of the transporter 20, or along the entire length of the transporter 20. In the illustrated embodiment, two sensor devices D are depicted. However, any appropriate number of sensor device(s) D can be selected depending on circumstances. In some embodiments, the sensor device(s) D can include one or more photo-light beam sensor, one or more photo-light sensor array, one or more pressure sensor, one or more camera and/or one or more appropriate sensor device to, e.g., detect when the flats (e.g., mail flats) are not being presented or delivered properly (e.g., to a sorting unit or the like).

When certain conditions are detected by these sensors, separate drive systems on the delivery system can be adapted to correct for, e.g., poorly loaded mail. For example, the moving devices 50 and 60 can be adapted to alter their respective speeds, accelerations, relative positions and/or the like. In this manner, an improved efficiency can be achieved. This can also enable a higher throughput, a reduction in damage to flats and/or to the system, a reduction in the amount of multi-fed pieces of mail and/or various other advantages. In some embodiments, an operator (such as, e.g., an operator Op1 or Op2 shown in FIG. 4) can affect or can partly control corrections (such as, e.g., via operator interfaces 75 shown in FIGS. 2 and 4), such as by receiving operator input to control the manner of correction, to control the extent of correction, to override operation and/or the like. However, substantial advantages can be obtained, in some preferred embodiments, by substantially eliminating the dependency of a machine's performance on an operator's ability to groom the mail while the operator loads the system. In some preferred embodiments, a substantially automatic or entirely automatic stack correction is provided.

In some preferred embodiments, a “decoupled” delivery system can thus be provided in which a pusher (e.g., a paddle) and a transporter (e.g., a transport system) can be moved independently to, e.g., correct against stacking errors. In some illustrative cases, stacking errors can include one or more of the following: a) excessive forward lean of one or more flat (such as, e.g., illustratively depicted in dashed lines at B in FIG. 1 and in FIG. 2); b) excessive rearward lean of one or more flat (such as, e.g., illustratively depicted in dashed lines at A in FIG. 1); c) excessive spacing between flats (such as, e.g., shown at FS in FIG. 2); d) excessive movement of flats independent of transporter movement (such as, e.g., shifting or the like); e) variation in flat height (such as, e.g., variation of height between adjacent flats and/or variation of height of a specific flat); f) variation in pressure (such as, e.g., lateral pressure upon a pusher and/or upon a system downstream of the pusher, such as a destacking unit); g) slippage or movement of flats during transport; and/or h) other conditions as would be now or later apparent to those in the art based on this disclosure. These and/or other error conditions can be sensed by a number of different methods including, e.g., that described above, such as, e.g., pressure sensors (which can be used, e.g., to sense lateral stack pressure at a destacker system and/or at a pusher system), cameras and/or photo arrays (which can be used, e.g., to sense the stack angle or the like), electromagnet wave or light beam sensors (which can include, e.g., sensing via through beams, reflective beams and/or a combination of thereof for detecting stack angle or the like). As discussed above, the system can further include PLCs, external PCs, programmable servo drives and/or other devices that can be used to control and adjust a stack of flats (e.g., mail flats) on the transporter.

Among other things, as discussed above, decoupling the transporter and pusher components and placing them on separate drive systems can enable movement the pusher system independently of the transporter system and vice versa. In some embodiments, if the system sensors detect that the mail is stacked too loosely (e.g., leaning away from the destacking surface), the pusher can be actuated to “tighten” the stack by moving toward the destacking system at a greater velocity than the transporter. In some embodiments, if the system sensors detect that the stack is “over tilted” (e.g., leaning towards the destacking system), the transporter can also be moved forward at a greater rate than the pusher. For example, when a stack of mail has been poorly loaded, since the pusher system is uncoupled from the transporter system, a sensing mechanism (e.g., located, for instance, at or proximate a downstream end of the transporter [e.g., at a destacking system]) can send a signal causing, e.g., the pusher to move forward until a good mail stack condition is achieved (e.g., is sensed).

Preferably, the transporter and the pusher can continue to move at a generally consistent velocity (such as, e.g., at a “normal” velocity corresponding to a particular apparatus “feed” rate) and the relative velocity there-between can be increased and/or decreased during such movement (e.g., via respective corrections). In this manner, the preferred embodiments should be able to increase throughput of the system and avoid errors that may decrease throughput. In less preferred embodiments, stack correction can include stopping the transport system as the pusher is moved forward and/or stopping the pusher as the transport system is moved forward. While these latter embodiments may be readily programmed and implemented, in some circumstances, these can be less preferable because, e.g., there may be a slight decrease in throughput of the system due to stoppage of respective devices.

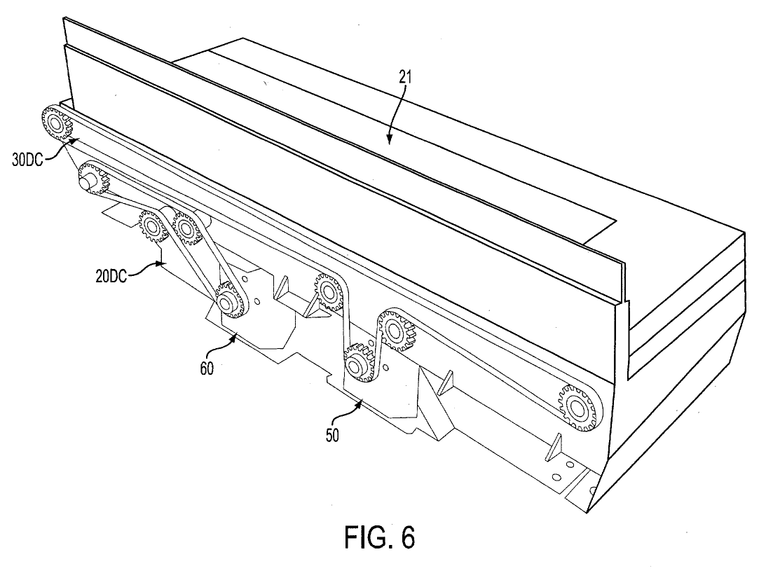

FIGS. 5-6 illustrate components of an automatic stack correction system in some illustrative embodiments of the invention. In these illustrative embodiments, portions of the apparatus (e.g., enclosure walls and the like) are omitted to reveal internal structure. These illustrative, and non-limiting, embodiments shown in FIGS. 5-6 include: asynchronously geared motors 50 and 60 with separate drive chains 30DC and 20DC, respectively, that drive the pusher and transporter systems independently; photo-light sensors (not shown) that signal when conditions exist for the systems to correct the stack angle; and a stand-alone computer (not shown) with software that controls the two independent systems.

According to some preferred embodiments, a method of upgrading an existing system (such as, e.g., an existing AFSM100 system) having synchronously coupled transporter and a pusher mechanisms can include modifying the existing system to include independently controlled drives for the transporter and the pusher mechanisms, such as discussed above. In this manner, an advantageous upgrade can be effectively and efficiently implemented.

While the preferred embodiments pertain to systems for handling mail, and the most preferred embodiments pertain to systems for handling mail flats, various embodiments of the invention can be used for handling all types of thin objects. The terminology “thin objects” includes all types of generally thin articles that are capable of being aligned in a side-by-side manner, stacked or the like. In certain preferred embodiments, a given system may handle a multitude of thin objects with different sizes, compositions, flexibilities (such as, e.g., substantially rigid, substantially flexible, etc.) and/or shapes at a given time. However, in the most preferred embodiments, the thin objects preferably fall within a predetermined range of characteristics. For example, in certain preferred embodiments, the system can be adapted to handle mail flats having one or more of the following characteristics discussed in the following three sections:

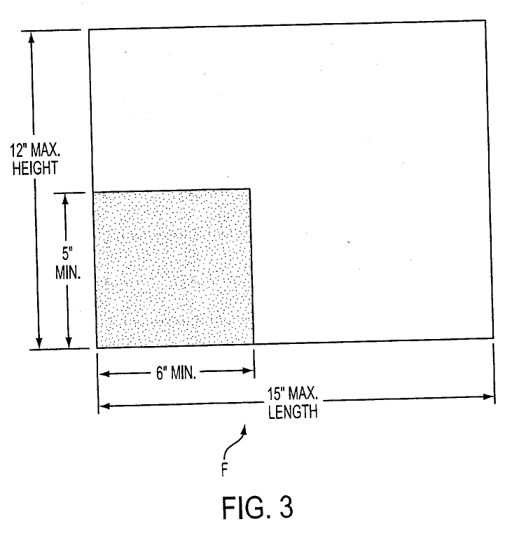

1. In some embodiments, each flat is generally rectangular and: a) has a height (such as shown in FIG. 3) of between about 12 inches and 5 inches; b) has a length (such as shown in FIG. 3) of between about 15 inches and 6 inches long; and/or c) has a thickness of between about 0.75 inches and 0.009 inches.

2. In some embodiments, each flat is also within one or more of the following weight limits: a) under about 13 ounces (e.g., for first-class mail); b) under about 16 ounces (e.g., for standard mail); and/or c) under about 20 ounces (e.g., for periodicals and bound printed matter).

3. In some embodiments, each flat also meets one or more, preferably all, of the following standards for “turning ability” and/or “deflection.”

Turning Ability

A mail flat preferably can fit between two concentric arcs drawn on a horizontal flat surface, one with a radius of less than about 16 inches (e.g., such as about 15.72 inches) and the other with a radius of less than about 17 inches (e.g., such as about 16.72 inches), with both arcs being about one inch apart or less, in preferably one or more of the following ways:
(1) Preferably, the piece is flexible enough to bend between the two arcs when positioned vertically, with (if applicable) a bound, folded or final folded edge perpendicular to the surface where the arcs are drawn.
(2) Preferably, if rigid (e.g., if constructed of or containing substantially inflexible materials), the piece is small enough to allow its longest edge to be placed between the two arcs without touching the lines of the arcs.
   Deflection

A mail flat is preferably also rigid enough so that, when placed flat on a surface to extend unsupported at least about 4 inches (preferably about 5 inches) off that surface, substantially no part of the edge of the piece that is opposite the bound, folded or final folded edge (if applicable) deflects more than about 1¾ inches (if the piece is less than about ⅛ inch thick) or more than about 2⅜ inches (if the piece is from about ⅛ to ¾ inch thick).

While some preferred embodiments involve the handling of flats having characteristics as detailed above, numerous other embodiments can be employed having various other flat configurations or specifications, such as, e.g., that disclosed in the '311 patent. The foregoing illustrative embodiments do not limit the broad applicability of the invention to various thin objects having other characteristics, which may vary widely depending on the particular circumstances.

While illustrative embodiments of the invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure or step are not recited.

1. A system for automated correction of a stack of mail, comprising:
a) a transporter having an endless transport belt upon which mail can be conveyed at a transport speed;
b) a first moving mechanism connected to said transporter to move said transport belt;
c) a generally upright pusher that is movable generally parallel to and over said transport belt, said upright pusher having an angle of recline of 10-20 degrees relative to perpendicular to said transport belt;
d) a second moving mechanism connected to said pusher and independent of said first moving mechanism;
e) at least one detector positioned to detect orientation of mail located upon said transport belt; and
f) at least one controller configured to control said first and second moving mechanisms in response to detection by said detector of an orientation error of mail on said transport belt, said controller including at least one computer, wherein, upon detection of an orientation error, said controller is configured to cause one of said first and second moving mechanisms to move the transporter or the pusher faster than the transport speed while the other of the first and second transport mechanisms moves the transporter or the pusher at the transport speed.

2. The system of claim 1, wherein said system is configured to sort mail flats.

3. A system for correcting a stack of thin objects, comprising:
a) a transporter having a transport surface;
b) a first moving device connected to said transporter;
c) a pusher having a generally upright pusher surface movable generally over said transport surface, said upright pusher having an angle of recline of 10-20 degrees relative to perpendicular to said transport surface;
d) a second moving device connected to said pusher;
e) at least one detector positioned to detect stack errors of thin objects located on said transport surface;
f) at least one controller configured to control at least one of said first and second moving devices in response to detection by said detector.

4. The system of claim 3, further including a multitude of mail items stacked side-by-side upon the transport surface, wherein said multitude of mail items have a multitude of sizes and weights.

5. The system of claim 4, wherein said mail items are mail flats.

6. The system of claim 3, wherein said controller includes at least one computer that is programmed to control a rate of at least one of said first and second moving devices.

7. The system of claim 3, wherein said detector detects an orientation of thin objects on said transport surface.

8. The system of claim 3, wherein an error is detected when the orientation of thin objects on said transport surface departs a predetermined extent from an orientation of said generally upright surface of said pusher.

9. The system of claim 3, wherein said pusher is supported for reciprocating movement on a substantially linear track.

10. The system of claim 3, wherein said first moving device includes a first electric servomotor that is coupled to a first drive chain.

11. The system of claim 10, wherein said second moving device includes a second electric servomotor that is coupled to a second drive chain, said first and second servomotors and said first and second drive chains operating independently.

12. A system for correcting a stack of thin objects, comprising:
a) a transporter having a laterally movable transport surface;
b) a pusher having a generally upright pusher surface movable generally along said transport surface, said pusher surface having an angle of recline of 10-20 degrees relative to perpendicular to said transport belt;
c) said transport surface being movable to transport thin objects at a transport speed and said pusher being movable generally parallel to said transport surface; and
d) means for controlling said transporter and said pusher to vary the speed of movement of said transporter or said pusher while the other continues to move at the transport speed based on a detected stack error.

13. The system of claim 12, wherein said means for controlling includes means for determining if thin objects are stacked more loosely than desired, and, thereupon, moving the pusher at a greater velocity than the transporter.

14. The system of claim 12, wherein said means for controlling includes means for determining if thin objects are over-tilted, and, thereupon, moving the transporter forward at a greater velocity than the transporter.

15. The system of claim 12, wherein said thin objects are mail items.

16. A method for correcting a stack of thin objects, comprising:
a) locating thin objects on a transporter having a transport surface;
b) moving the thin objects upon the transport surface at a transport speed while a pusher supports the thin objects in a generally upright orientation; and
c) adjusting the relative speeds of the transporter and the pusher upon the detection of a stack error such that the speed of one of the transporter and the pusher is greater than the transport speed while the other of the transporter and the pusher continues to move at the transport speed.

17. The method of claim 16, further including determining that thin objects are stacked more loosely than desired, and wherein said adjusting includes moving the pusher at a greater velocity than the transporter.

18. The method of claim 16, further including determining that thin objects are over-tilted, and wherein said adjusting includes moving the transporter forward at a greater velocity than the pusher.

19. The method of claim 16, wherein said locating thin objects on the transporter includes locating mail on the transporter.

20. A method for upgrading a mail sorting system having a transporter upon which mail is supported for movement at a transport speed and a pusher against which mail is supported during movement, wherein said pusher and said transporter are originally connected to move synchronously via the same drive mechanism, comprising:
a) replacing the single drive mechanism with independent drive mechanisms for said transporter and said pusher; and
b) controlling said independent drive mechanisms to move said transporter and said pusher at different relative speeds based upon errors in the orientation of mail upon said transporter such that the speed of one of said transporter and said pusher is greater than the transport speed while the other of said transporter and said pusher continues to move at the transport speed.

21. The method of claim 20, further including determining that the mail is stacked more loosely than desired, and wherein said controlling includes moving the pusher at a greater velocity than the transporter.

22. The method of claim 20, further including determining that mail is over-tilted, and wherein said controlling includes moving the pusher forward at a greater velocity than the transporter.
